(19) United States
(12) Patent Application Publication
(10) Pub. No.: US 2024/0327313 A1
(43) Pub. Date: Oct. 3, 2024

(54) THROTTLEABLE SOLID PROPELLANT SYSTEM AND METHOD

(71) Applicant: Purdue Research Foundation, West Lafayette, IN (US)

(72) Inventors: Steven F. Son, West Lafayette, IN (US); Derek Keith Messer, West Lafayette, IN (US); Cohen Thomas Vestal Nunes, West Lafayette, IN (US); Thomas Hafner, Lafayette, IN (US)

(73) Assignee: Purdue Research Foundation, West Lafayette, IN (US)

(21) Appl. No.: 18/437,519

(22) Filed: Feb. 9, 2024

Related U.S. Application Data
(60) Provisional application No. 63/444,800, filed on Feb. 10, 2023.

(51) Int. Cl. C06D 5/00; F02K 9/10; F03G 7/06

(52) U.S. Cl. CPC C06D 5/00; F03G 7/06143; F03G 7/0616; F02K 9/10

(57) ABSTRACT

The throttleable solid propellant system includes a substantially solid propellant, a shape-altering structure, and an actuation source. The shape-altering structure is at least partially disposed within the substantially solid propellant. The actuation source is to be coupled to the shape-altering structure. The actuation source is to be configured to actuate the shape-altering structure between a first position and a second position. Transitioning the shape-altering structure between the first position and the second position may crack and/or deform the substantially solid propellant. Cracking and/or deforming the substantially solid propellant may increase the burning surface area of the propellant, thereby altering the thrust produced from the throttleable solid propellant system.

### CROSS REFERENCE TO RELATED APPLICATIONS

This application claims the priority benefit of U.S. Provisional Patent application No. 63/444,800, filed Feb. 10, 2023, the contents of which is incorporated herein by reference in its entirety.

### GOVERNMENT RIGHTS

This invention was made with government support under FA9550-19-1-0008 awarded by the Air Force Office of Scientific Research. The government has certain rights in the invention.

### FIELD

The disclosure generally relates to propellant systems and, more particularly, to throttleable propellant systems.

### INTRODUCTION

This section provides background information related to the present disclosure which is not necessarily prior art.

Solid rocket propellants are commonly used because of their feasibility to manufacture, ease of use, and long shelf life; however, they are limited by the inability to actively control the burning rate. Throttleable propellants have been demonstrated through space rendezvous, orbital maneuvering, limiting vehicle acceleration or velocity using retrograde rockets, and ballistic missile defense trajectory control. However, known examples of throttleable propellants come from liquid or hybrid rocket engines while throttleable solid propellants remain largely undiscovered. Throttleable rocket engines serve as a critical technology for space flight applications since they can optimize a vehicle's performance by providing the most economical amount of thrust at any given time. Additionally, varying performance with time enables planetary landings and precise orbital maneuvers. Current fully developed methods of throttling solid rocket motors includes custom grain geometries, nozzle throat area modifications and electrically controlled solid propellants (ECSPs). Custom grain geometries must be determined prior to manufacturing, resulting in the inability to modify the performance of the motor on demand during the burn. Alternatively, altering the throat area of the nozzle can change the exit velocity and therefore adjust the thrust of the motor during flight. This comes with additional complications due to the temperature of the exhaust gas restricting usable materials and mechanisms or requiring an additional fluid flow to limit the throat area. Furthermore, ECSPs cannot yet replace conventional solid propellants because the required chemical composition greatly limits and impairs the burning rate.

Accordingly, there is a continuing need for a throttleable solid propellant system and a method that may tune and manipulate the burning behavior of a propellant on demand. Desirably, the throttleable solid propellant system may be more efficiently utilized in a rocket system compared to known propellants.

### SUMMARY

In concordance with the instant disclosure, a throttleable solid propellant system and method that may tune and manipulate the burning behavior of a propellant on demand has surprisingly been discovered. Desirably, the throttleable solid propellant system and method may be more efficiently utilized in a rocket system compared to known propellants.

The throttleable solid propellant system includes a substantially solid propellant, a shape-altering structure, and an actuation source. The shape-altering structure may be at least partially disposed within the substantially solid propellant. In a more specific example, a majority of the shape-altering structure may be embedded within the substantially solid propellant. The actuation source may be coupled to the shape-altering structure. The actuation source may be configured to actuate the shape-altering structure between a first position and a second position.

Various ways of manufacturing the throttleable solid propellant system are provided. For instance, a first method may include a step of providing a substantially solid propellant, a shape-altering structure, and an actuation source. The shape-altering structure may be disposed in a first position. As a non-limiting example, the first position may include a coil and/or spring shape. The shape-altering structure may be at least partially disposed in the substantially solid propellant. In a specific example, the substantially solid propellant may be melted and the shape altering structure may be disposed in the melted propellant before the propellant is allowed to cool and solidify. In another specific example, the shape altering structure may be pushed and/or twisted into the substantially solid propellant. Next, the method may include a step of coupling the shape altering structure to the actuation source. In a specific example, the shape altering structure may be electrically coupled to the actuation source. It should be appreciated the order of the steps of the first method may be rearranged, as desired. One skilled in the art may select other suitable methods of manufacturing the throttleable solid propellant system, within the scope of the present disclosure.

Various ways of using the throttleable solid propellant system are provided. For instance, a second method may include a step of engaging the actuation source to apply an electrical current to the shape altering structure. Next, the shape altering structure may transition from a first position to a second position. Then, the substantially solid propellant may be cracked and/or deformed, thus enhancing the burning rate of the substantially solid propellant from the increased surface area. In certain circumstances, the second method may include a step of adjusting the amount of electrical current applied to the shape altering structure based on the burning rate of the substantially solid propellant. A skilled artisan may select other suitable ways of using the throttleable solid propellant system, within the scope of the present disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a schematic diagram of a throttleable solid propellant system, according to one embodiment of the present disclosure;

FIG. 2 is cross-sectional front elevational view taken from A-A in FIG. 1 illustrating the shape-altering structure partially disposed as a coil in the propellant, according to one embodiment of the present disclosure;

FIG. 3 is a flowchart illustrating a method of manufacturing a throttleable solid propellant system, according to one embodiment of the present disclosure;

FIG. 4 is a flowchart illustrating a method of using a throttleable solid propellant system, according to one embodiment of the present disclosure;

FIG. 5 is a front elevational view of a setup used to train, or shape-set, the shape-altering structure into a spring shape, according to one embodiment of the present disclosure;

FIG. 6 is a front perspective view of a shape-altering structure disposed in a first position, according to one embodiment of the present disclosure;

FIG. 7 is a front perspective view of the shape-altering structure, as shown in FIG. 6, further depicting the shape-altering structure transitioned into a second position, according to one embodiment of the present disclosure;

FIG. 8 is a front perspective view of a shape-altering structure disposed in a first position within a propellant, according to one embodiment of the present disclosure;

FIG. 9 is a front perspective view of the shape-altering structure, as shown in FIG. 8, further depicting the shape-altering structure disposed in a second position within the propellant, causing cracks and deformations to form in the propellant, according to one embodiment of the present disclosure;

FIG. 10 is a line graph comparing the pressure traces between burning the propellant with a shape-altering structure disposed in the first position (compressed) and the second position (expanded), further depicting the shape-altering structure disposed in the second position is consumed much more quickly due to the increase in surface area;

FIG. 11 is a line graph comparing the differential pressures between burning the propellant with a shape-altering structure disposed in the first position (compressed) and the second position (expanded), further depicting the shape-altering structure disposed in the second position achieves a higher rate of pressurization;

FIG. 12 is a line graph comparing the vivacity between burning the propellant with a shape-altering structure disposed in the first position (compressed) and the second position (expanded), further depicting the capacity to actively control the dP/dt or vivacity by selectively increasing the surface area of the propellant using the shape-altering structure;

FIG. 13 is a schematic diagram illustrating the separation of a substantially solid propellant, further depicting the shape-altering structure transitioning from a first position to a second position to a third position, according to one embodiment of the present disclosure; and

FIG. 14 is a plot diagram illustrating the experimental results of the throttleable solid propellant system setup, as shown in FIG. 13, further depicting a comparison of actuation to a rate of pressurization, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Known solid propellants, with the exception of the less effective electrically controlled solid propellants, do not have the benefit of active burning rate control; however, the burning behavior can be modified by introducing defects such as cracks, gaps, and slots. The use of defects for throttling a solid rocket motor is motivated by a propellant's mass burning rate and therefore thrust, being proportional to its exposed surface area. Cracks and defects in the propellants can increase the burning surface area and thrust of the motor. The uncontrolled introduction of defects can lead to additional cracks and defects that can transition to detonation due to an increase in pressure. Therefore, the desired burning rate can be manipulated if the size and location of the introduced defects can be controlled in a predictable manner. However, there are some constraints on the minimum size of the introduced defect since the increase in thrust only occurs if the flame can successfully propagate into the defect. One way to create defects in propellants is to embed and actuate a shape altering structure, such as a spring. In a specific example, the spring may be a shape memory alloy (SMA) spring that is feasible to control and generates enough stress within the grain.

SMA's are materials that have the unique characteristic of returning to an originally “set” shape when exposed to heating above a specific critical temperature. Below this temperature and stress level, the material is easily deformable and soft. Nickel-titanium, or nitinol, is a popular SMA with well-established electrical, mechanical, and thermal properties. One skilled in the art may select other suitable SMA materials to form the shape altering structure, within the scope of the present disclosure. Nitinol has two phases, austenite and martensite, which are thermodynamically favored differently depending on temperature. The austenite phase is preferred at temperatures above the critical temperature and martensite phase is favored under the critical temperature. The two phases exhibit different crystal structures that result in internal stresses when the temperature is changed, leading to the presence of the shape memory effect. Previous studies utilize nitinol for actuation applications, however, none of the known applications involved solid propellants. For example, previous work tested a one-millimeter-thick nitinol spring under various loads and found it was able to operate at 7 N of force while achieving 161 MPa of effective stresses in its coils. Accordingly, the performance of nitinol under these intense loads may actuate enough to induce defects in a solid propellant for which it is embedded.

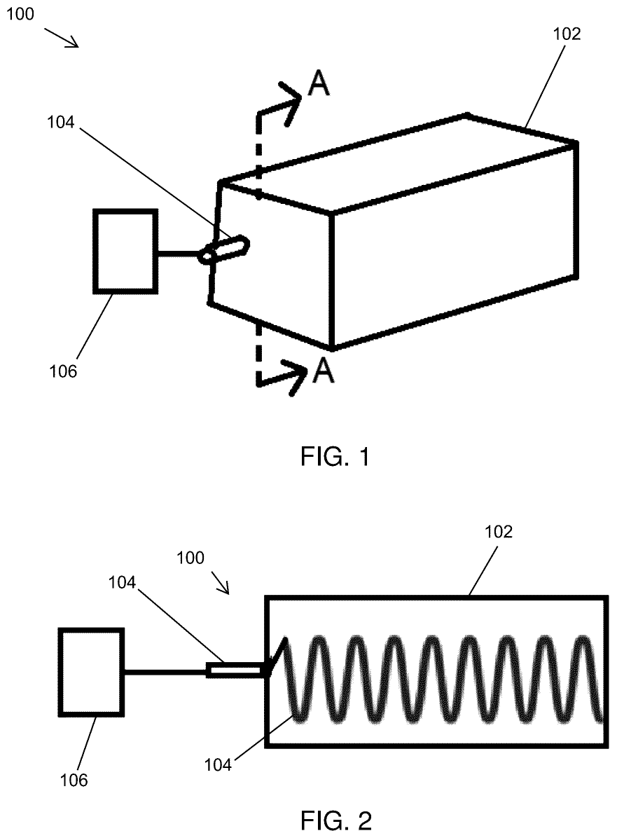

As shown in FIGS. 1-2, the throttleable solid propellant system 100 includes a substantially solid propellant 102, a shape-altering structure 104, and an actuation source 106. In a specific example, the substantially solid propellant 102 may be completely solid. The shape-altering structure 104 may be at least partially disposed within the substantially solid propellant 102. In a more specific example, a majority of the shape-altering structure 104 may be embedded within the substantially solid propellant 102. The actuation source 106 may be coupled to the shape-altering structure 104. The actuation source 106 may be configured to actuate the shape-altering structure 104 between a first position 1P and a second position 2P.

The substantially solid propellant 102 may be provided in various ways. For instance, the substantially solid propellant 102 may include Ammonium Perchlorate/hydroxyl-terminated polybutadiene (AP/HTPB). The AP/HTPB solid composite propellant may include a relatively high solids loading rate. In a specific example, the AP/HTPB solid composite propellant may include around 85% solids loading. A skilled artisan may select other suitable materials to provide the substantially solid propellant 102, within the scope of the present disclosure.

The shape-altering structure 104 may be provided in various ways and include various functions. For instance, the shape-altering structure 104 may be selectively actuated between a first position 1P and a second position 2P. In a specific example, the shape-altering structure 104 may include a metal wire. In a more specific example, the metal wire may be shaped as a spring. In an even more specific example, the metal wire may be a nichrome wire. The spring may include stored potential energy to selectively transition between the first position 1P and the second position 2P. In an alternative example, the spring may be selectively transitioned between the first position 1P and the second position 2P using an actuation source 106. In certain circumstances, the shape-altering structure 104 may include an SMA material. In a non-limiting example, the shape-alerting structure including the SMA material may be provided in the shape of a spring. One skilled in the art may select other suitable materials, structures, or methods for providing the shape-altering structure 104, within the scope of the present disclosure.

The actuation source 106 may be provided in various ways. For instance, the actuation source 106 may be configured to heat the shape-altering structure 104. In a specific example, the actuation source 106 may heat the shape-altering structure 104 via joule heating with an electrical current. In a more specific example, the electrical current provided by the actuation source 106 may be actuated in a binary manner, such as “on/off” conditions. In a more specific example, the binary manner of the actuation may selectively apply a fixed electrical current in the “on” condition until the actuation source 106 selectively applies the “off” condition, where no electrical current is applied to the shape-altering device. In an alternative example, the electrical current provided by the actuation source 106 may be actuated in a non-binary manner. The non-binary manner of actuation may include variable actuation parameters which may have three or more conditions. For instance, unlike binary stimuli which is limited to only the “on” condition and the “off” condition, the non-binary manner of actuation may provide variable actuation parameters such as current amplitude and/or a duration of the electrical current application. More specifically, the current amplitude may include a zero-amplitude state, a low amplitude state, and a high amplitude state. In a non-limiting example, the low amplitude state may be around seven amps and the high amplitude state may be around ten amps. It should be appreciated that any number of amplitude states or any amount of electrical current may be utilized, within the scope of the present disclosure. The duration of electrical current application may include no electrical current, a brief period of electrical current (such as one second), and an extended period of electrical current (such as five seconds). One skilled in the art may select other suitable variable actuation parameters, within the scope of the present disclosure.

Where variable actuation parameters are utilized in the throttleable solid propellant system 100, the actuation source 106 may gradually increase the temperature of the shape-altering structure 104. Advantageously, by gradually increasing the temperature of the shape-altering structure 104, the shape-altering structure 104 may be selectively disposed in a third position between the first position 1P and the second position 2P. For instance, where the shape-altering structure 104 is provided as a spring including SMA material, the first position 1P may be a compressed position, the second position 2P may be an expanded position, and the third position may be a semi-compressed position. Where no heat is applied from the actuation source 106, the shape-altering structure 104 may be disposed in the compressed position. Where a low amplitude state of electrical current from the actuation source 106 is applied to the shape-altering structure 104, the shape-altering structure 104 may be disposed in the semi-compressed position. Where a high amplitude state of electrical current from the actuation source 106 is applied to the shape-altering structure 104, the shape-altering structure 104 may be disposed in the expanded position. In other words, by controlling the electrical current provided from the actuation source 106 to the shape-altering structure 104, the positioning of the shape-altering structure 104 may be tuned and adjusted on a range of positions, rather than solely indexed between only two positions. Desirably, this tunability of positioning of the shape-altering structure 104 may enable on-demand burning behavior manipulation of the substantially solid propellant 102.

In certain circumstances, the transition of the shape-altering structure 104 from the first position 1P to the second position 2P may change the shape of the substantially solid propellant 102. For instance, where the shape-altering structure 104 is disposed at least partially within the substantially solid propellant 102, transitioning the shape-altering structure 104 from the first position 1P to the second position 2P may deform and/or crack the substantially solid propellant 102 which may increase a burning surface area of the substantially solid propellant 102, which may thereby enhance the thrust of a motor. Advantageously, by controlling the amount of the electrical current delivered to the shape-altering structure 104, the deformation and/or cracking of the substantially solid propellant 102 may be controlled more precisely. Also, if an on-demand change is necessary, such as if more thrust is need than what was initially calculated, the throttleable solid propellant system 100 may increase the electrical current utilized to expand the shape-altering structure 104 further, which may enhance the burning surface area of the solid propellant, thereby encouraging more thrust from the motor. Desirably, by expanding the shape-altering structure 104 to increase the burning surface area of the substantially solid propellant 102, the burning rate of the substantially solid propellant 102 may be enhanced by two-fold or more. In other words, the shape-altering structure 104 may be adjusted on-demand and/or in real-time from the second position 2P to a third position 3P. On-demand adjustment may be understood as transitioning the shape-altering structure 104 from the second position 2P to the third position 3P after an ignition of the substantially solid propellant 102 has already occurred. For instance, where the burning rate of the throttleable solid propellant system 100 is determined to be insufficient after adjusting the shape altering structure 104 to the second position 2P, the shape-altering structure 104 may be further adjusted to the third position 3P in real time. Known solid propellant systems are unable to apply these on-demand changes to alter the amount of the thrust beyond what was previously calculated, before launching the propellant, without the addition of complex external mechanisms.

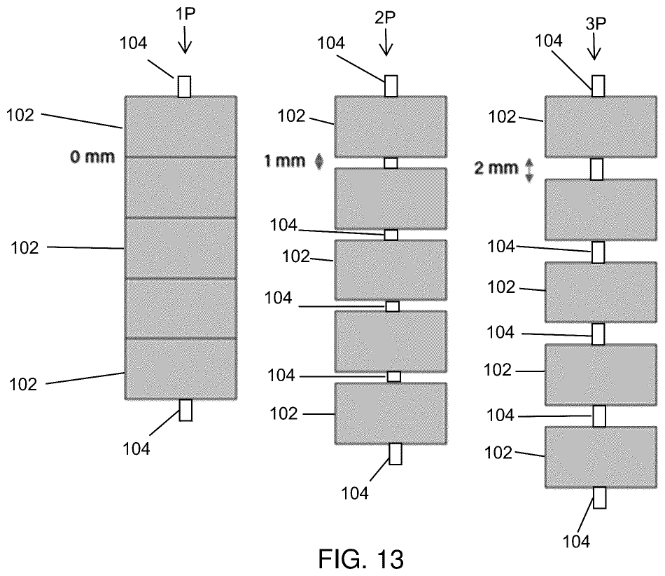

In certain circumstances, by engaging the shape-altering structure 104, the surface area the substantially solid propellant 102 from the first position 1P to the second position 2P may be increased, namely through controlled tearing and cracking the substantially solid propellant 102. In a specific example, the substantially solid propellant 102 may be provided with a plurality of layers. The plurality of layers may be configured to separate with the engagement of the shape-altering structure 104. In a more specific example, as shown in FIG. 13, the shape-altering structure 104 may be engaged with the variable actuation parameters, as previously discussed, to adjust the size of the gaps between the plurality of layers equal the amount of adjusted actuation. For instance, the size of the gap and/or gaps between the plurality of layers substantially solid propellant 102 may be adjusted from zero millimeters in the first position 1P to around one millimeter in the second position 2P. However, if desired, the actuation of the shape-altering structure 104 may be further adjusted to change the size of the gap and/or gaps between the plurality of layers of substantially solid propellant 102 from one millimeter in the second position 2P to around two millimeters in the third position 3P. One skilled in the art may select any suitable number of layers or size of gaps, within the scope of the present disclosure.

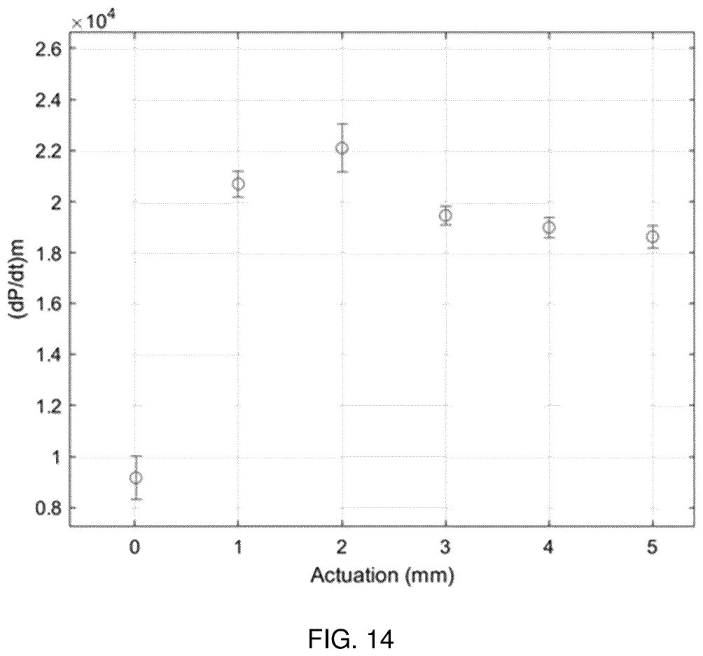

Provided as a non-limiting example, an experiment was conducted to determine how actuation affects the rate of pressurization. Each of the plurality of layers of the substantially solid propellant 102 was provided having a mass of about one gram and about five millimeters thick. The shape altering structure 104 was provided as a nichrome wire to hold the layers together. In the non-limiting experiment, the plurality of layers substantially solid propellant 102 were increasingly actuated to provide gaps ranging from around one millimeter to around five millimeters between the plurality of layers. As shown in FIG. 14, a comparison between actuation and rate of pressurization was performed. The rate of pressurization was found by deriving the values from pressure versus time and the max value was chosen for (dP/dt)m. The samples that were not actuated had a max dP/dt value lower than any actuated sample. As actuation increases to around two millimeters, max dP/dt sharply increases to 22,000 psi/s. For the subsequential values, the rate of pressurization decreases as actuation increases. This may imply that there is a specific range of actuation that outputs the best performance, or optimal rate of pressurization. Desirably, the throttleable solid propellant system 100 may not only improve performance but may also be tailored to a desired output.

Desirably, the throttleable solid propellant system 100 may enhance the efficiency of rocket systems. For instance, the throttleable solid propellant system 100 may be added to the rocket system with a negligible weight increase. More particularly, weight of the propellant is null given the standard rocket system would have to account for the weight of a propellant. The weight of the actuation source 106 may be minimized if an existing electrical source on the rocket system can be also utilized for the purpose of the actuation source 106. Finally, the weight of the shape-altering structure 104 may be deemed minimal if the shape-altering structure 104 is provided as a wire. Additionally, the throttleable solid propellant system 100 advantageously does not require the use of actuators to adjust the throat area of the nozzle, as required in known on-demand throttle adjustment systems.

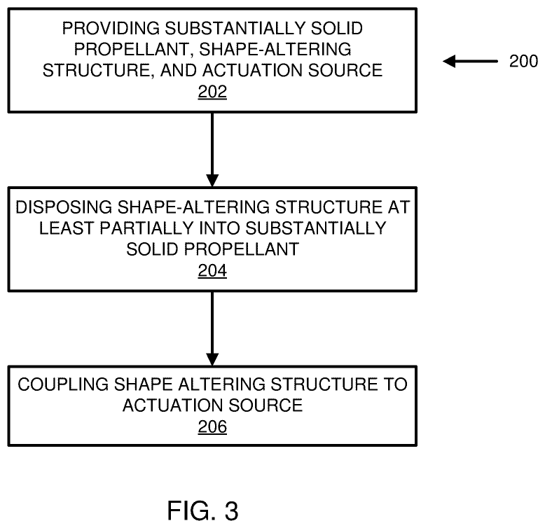

Various ways of manufacturing the throttleable solid propellant system 100 are provided. For instance, as shown in FIG. 3, a first method 200 may include a step 202 of providing a substantially solid propellant 102, a shape-altering structure 104, and an actuation source 106. The shape-altering structure 104 may be disposed in a first position 1P. As a non-limiting example, the first position 1P may include a coil and/or spring shape. The shape-altering structure 104 may be at least partially disposed in the substantially solid propellant 102. In a specific example, the substantially solid propellant 102 may be melted and the shape altering structure 104 may be disposed in the melted propellant before the propellant is allowed to cool and solidify. In another specific example, the shape altering structure 104 may be pushed and/or twisted into the substantially solid propellant 102. Next, the first method 200 may include a step 206 of coupling the shape altering structure 104 to the actuation source 106. In a specific example, the shape altering structure 104 may be electrically coupled to the actuation source 106. It should be appreciated the order of the steps of the first method 200 may be rearranged, as desired. One skilled in the art may select other suitable methods of manufacturing the throttleable solid propellant system 100, within the scope of the present disclosure.

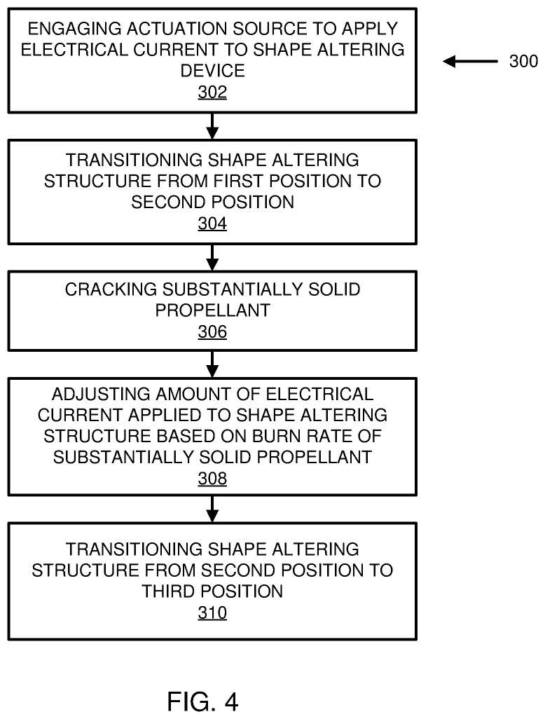

Various ways of using the throttleable solid propellant system 100 are provided. For instance, as shown in FIG. 4, a second method 300 may include a step 302 of engaging the actuation source 106 to apply an electrical current to the shape altering structure 104. Next, the shape altering structure 104 may transition from a first position 1P to a second position 2P. Then, the substantially solid propellant 102 may be separated. In a specific example, the separation of the substantially solid propellant 102 may including cracking and/or deforming a surface of the substantially solid propellant 102, thus enhancing the effective burning rate of the substantially solid propellant 102. In a more specific example, the substantially solid propellant 102 may be separated into a plurality of layers having a gap between each of the plurality of layers. In certain circumstances, the second method 300 may include a step 308 of adjusting the amount of electrical current applied to the shape altering structure 104 based on the burning rate of the substantially solid propellant 102. A skilled artisan may select other suitable ways of using the throttleable solid propellant system 100, within the scope of the present disclosure.

### EXAMPLE

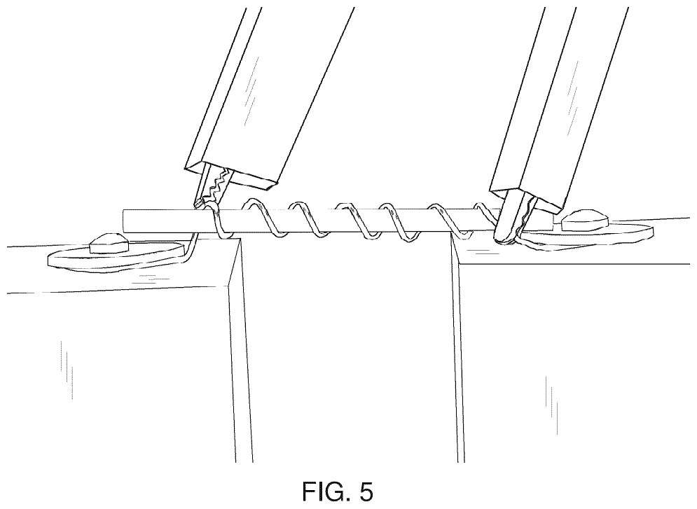

Provided as a non-limiting example, a nitinol spring was embedded in Ammonium Perchlorate/hydroxyl-terminated polybutadiene (AP/HTPB) solid composite propellant with 85% solids loading at a mass of 5 grams to demonstrate the throttleable propellant. A Shape-Memory Nitinol Wire commercially available from MCMASTER-CARR® was used. The Shape-Memory Nitinol Wire meets the ASTM F2063 specifications. A thickness of 0.04 in was used in a spring shape to optimize burning rate. FIG. 5 shows the set-up used to train, or shape-set, the nitinol wire into a desired spring shape. The SMA wire was coiled around a ceramic rod with a diameter of 0.125 in and the pitch was set to 0.25 in. The nitinol was trained by elevating its temperature to 500 C with joule heating for 15 minutes. The resulting spring was compressed to a pitch size of 0.125 in and embedded into a propellant sample.

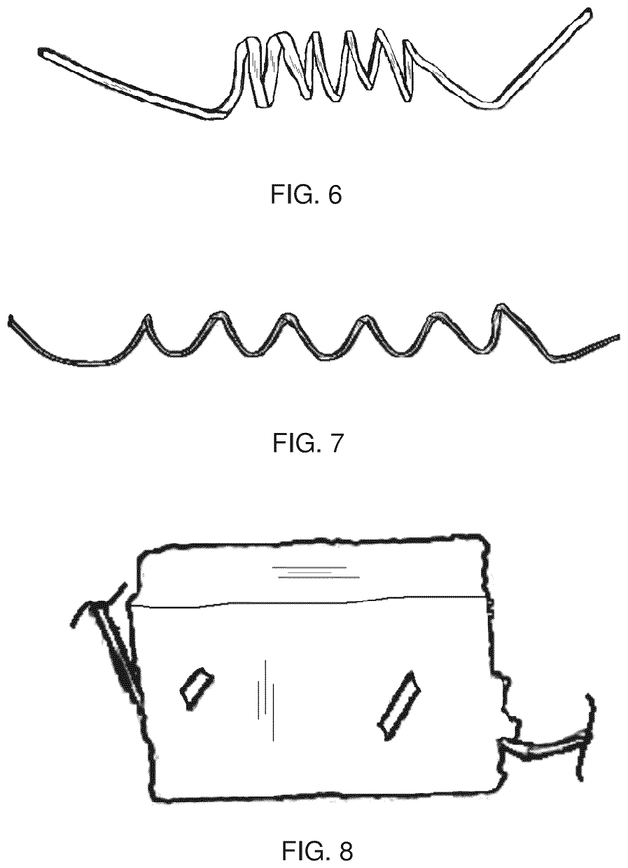

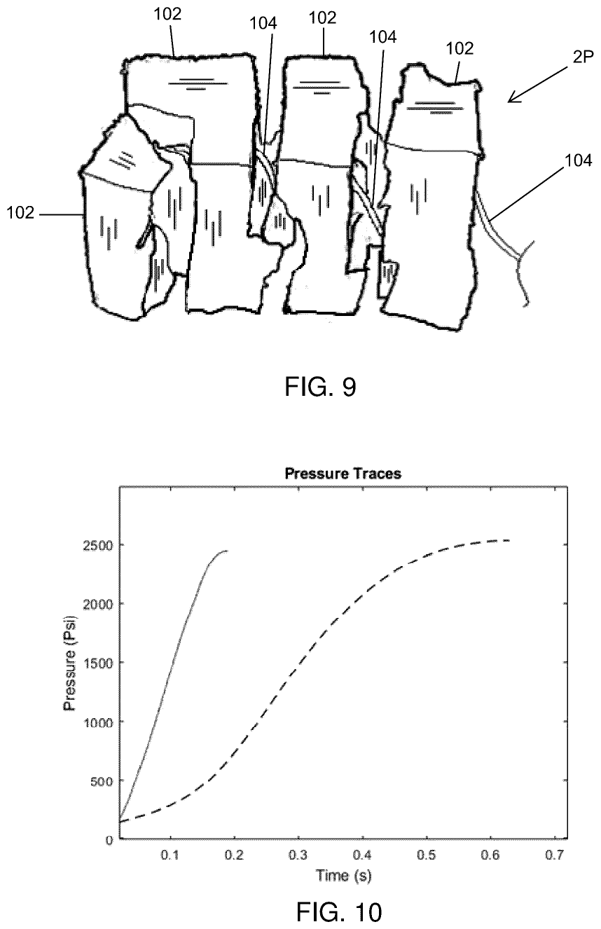

The nitinol spring was actuated without reaching the ignition threshold of the propellant to isolate the effects of the nitinol spring actuation. FIGS. 6 and 8 illustrate the compressed spring before and after being embedded, respectively. Joule heating was then used to raise the spring to its transition temperature of 120 degrees Celsius which will cause it to actuate to its trained expanded pitch size, as shown in FIG. 7. During actuation, the nitinol spring began creating cracks and tears within the propellant shown in FIG. 9, demonstrating its ability to generate the required stresses within the propellant and open more surface area. Both actuated and not actuated samples were then ignited with an external nichrome wire in a closed vessel with a volume of 9.42 in³. The pressure inside the vessel was measured using a PCB Piezotronics 113B22 pressure transducer.

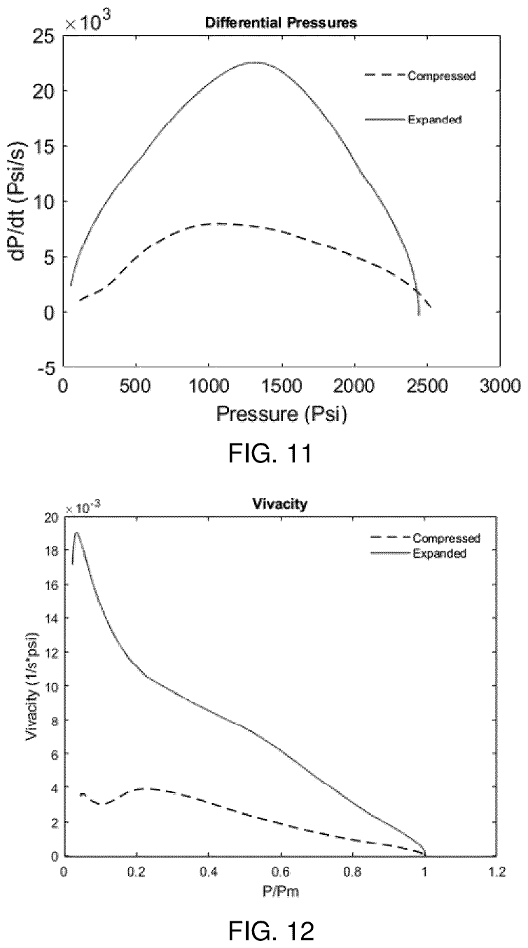

The pressure traces were measured to make a comparison on the change of pressurization due to actuation. FIG. 10 displays the pressure reading for burning AP/HTPB propellants with a compressed and expanded nitinol spring. FIG. 11 displays the rate of pressurization reading for the burning composite propellants with a compressed and expanded spring. The propellant with the unflexed spring reached a max pressure of 2,532 psi with a pressure rise rate of 7,969 psi/s. The sample burned after actuation reached a similar max pressure of 2,440 psi and displayed a much higher pressurization rate of 22,456 psi/s. This experiment also showed that a propellant with a mass of 5 g can be consumed three times faster, from 0.63 to 0.19 seconds, with surface area addition from the expanded spring. FIG. 12 displays the vivacity plotted against percent of max pressure (from 5% to 100%). Vivacity is the measure of quickness and efficiency of a propellant to produce energy while undergoing combustion. The difference in vivacity shows that for a given throttleable propellant system, the range of applications increases because of the range of energy outputs at a given time. For a given propellant, we can change the dP/dt or vivacity just by the increase of surface area from actuating the spring. The advantage of this method is that the user can decide whether to actuate or not, thereby introducing active control to a regular solid propellant.

Furthermore, the amount of actuation can be controlled. Previously, the burning rate was compared for AP/HTPB propellant embedded with a nitinol spring before and after binary actuation. The amount of actuation was varied with a power source that applied current between 7-10 amps. The resulting power produced via joule heating will establish an equilibrium temperature for the nitinol spring, thereby relating temperature to current. The transition of the nitinol from its martensite phase to its austenite phase is not an instantaneous process and occurs gradually as the temperature increases. The proportion of austenite to martensite dictates how much expansion the spring undergoes, therefore allowing for a specified expansion to be set by controlling the current. It is expected that the burning rate of propellants with an embedded SMA spring will correlate with the amount of electrical current the spring receives to actuate. When a low amount of current is applied, the spring may actuate to only a portion of its austenite phase. This will showcase a range of current in amperes versus a range of desired rates of pressurization to throttle to.

Advantageously, the burning rate of substantially solid propellant 102 may be tunable and manipulated on demand with the at least partially embedded shape-altering device. The defects introduced in the substantially solid propellant 102 may increase the effective burning rate proportional to spring actuation.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A throttleable solid propellant system comprising:
a substantially solid propellant;
a shape-altering structure at least partially disposed in the substantially solid propellant;
an actuation source coupled to the shape-altering structure, the actuation source configured to actuate the shape-altering structure between a first position and a second position.

2. The throttleable solid propellant system of claim 1, wherein the substantially solid propellant includes Ammonium Perchlorate/hydroxyl-terminated polybutadiene (AP/HTPB).

3. The throttleable solid propellant system of claim 1, wherein the shape-altering structure is a metal wire.

4. The throttleable solid propellant system of claim 3, wherein the metal wire is provided in the shape of a spring.

5. The throttleable solid propellant system of claim 3, wherein the metal wire includes a shape memory alloy material.

6. The throttleable solid propellant system of claim 5, wherein the shape memory alloy material is nitinol.

7. The throttleable solid propellant system of claim 1, wherein the actuation source is a joule heating source electrically coupled to the shape-altering structure.

8. The throttleable solid propellant system of claim 5, wherein the actuation source actuates the shape-altering structure in a binary manner, having two or less actuation parameters.

9. The throttleable solid propellant system of claim 5, wherein the actuation source actuates the shape-altering structure in a non-binary manner, having three or more actuation parameters.

10. The throttleable solid propellant system of claim 7, wherein the actuation source includes an actuation parameter which includes a current amplitude.

11. The throttleable solid propellant system of claim 7, wherein the actuation source includes an actuation parameter which includes a duration of the electrical current application.

12. A method of manufacturing a throttleable solid propellant system, the method comprising the steps of:
providing a substantially solid propellant, a shape-altering structure, and an actuation source;
disposing the shape-altering structure at least partially into the substantially solid propellant; and
coupling the shape altering structure to the actuation source.

13. The method of claim 12, wherein the step of disposing the shape-altering structure at least partially into the substantially solid propellant includes melting the substantially solid propellant and disposing the shape-altering structure within the melted propellant before allowing the melted propellent to cool back into the substantially solid propellant.

14. The method of claim 12, wherein the step of disposing the shape-altering structure at least partially into the substantially solid propellant includes pushing the shape-altering structure into the substantially solid propellant.

15. A method of using a throttleable solid propellant system, the method comprising the steps of:
engaging the actuation source to apply an electrical current to the shape altering structure;
transitioning the shape altering structure from a first position to a second position;
separating the substantially solid propellant.

16. The method of claim 15, further comprising a step of adjusting the amount of electrical current applied to the shape altering structure based on a burning rate of the substantially solid propellant.

17. The method of claim 16, further comprising a step of transitioning the shape altering structure from the second position to a third position.

18. The method of claim 17, wherein the step of transitioning the shape altering structure from the second position to the third position is adjusted on-demand.

19. The method of claim 15, wherein the substantially solid propellant is separated into a plurality of layers having a gap between each of the plurality of layers.

20. The method of claim 15, wherein the step of separating the substantially solid propellant includes cracking a surface of the substantially solid propellant.
